(19) United States
(12) Patent Application Publication
(10) Pub. No.: US 2016/0165839 A1
(43) Pub. Date: Jun. 16, 2016

(54) DOG BOWL HAVING AN INDENTED AREA TO PERMIT A COVERING TO REMOVABLY ATTACH

(71) Applicant: Steven Scaba, New York, NY (US)

(72) Inventor: Steven Scaba, New York, NY (US)

(21) Appl. No.: 14/565,434

(22) Filed: Dec. 10, 2014

(51) Int. Cl. A01K 5/01

(52) U.S. Cl. CPC A01K 5/0135

(57) ABSTRACT

Disclosed is a dog bowl having an indented area to permit a rubber covering to removably attach. In one aspect, the dog bowl includes a container area and the indented area below the container area formed of a ceramic material. A base of the dog bowl beneath the indented area is also formed of the ceramic material. A covering is removably attached to the base of the dog bowl by physically clasping into the indented area when pulled over a base region into the indented area such that the covering fully encapsulates a bottom of the base of the dog bowl.

### FIELD OF THE TECHNOLOGY

This disclosure relates generally to pet bowls for feeding animals, and more particularly to a dog bowl having a covering, preferably a covering to the base that can be removably attached, according to one embodiment.

### BACKGROUND

A dog bowl may be an open topped container designed to facilitate a feeding of a dog. The dog bowl may occasionally move about when the dog begins to eat food placed inside the dog bowl. Sometimes, the dog bowl may tip over. This may create clean up issues for a caretaker. In addition, sometimes the dog bowl may crack because of slippage while the dog is eating (e.g., when the dog bowl is placed on a hard surface such as tile flooring, a laminate flooring, a wood flooring, etc.). Furthermore, the dog bowl may rattle about when the dog is eating making it more difficult for the dog to access all the food inside the dog bowl. Such problems make the dog bowl less than an ideal device to feed the dog.

### SUMMARY

Disclosed is a dog bowl having an intended area to permit a covering to removably attach. In one aspect, a dog bowl includes a container area and an indented area below the container area formed of a ceramic material. A base of the dog bowl beneath the indented area is also formed of the ceramic material. A covering is removably attached to the base of the dog bowl by physically clasping into the indented area when pulled over a base region into the indented area (e.g., such that the covering fully encapsulates a bottom of the base of the dog bowl). The covering may prevent the dog bowl from slipping when a dog is eating food at an accelerated pace. The covering may remain clasped to the indented area while the dog is eating food from within the dog bowl. The dog bowl with the covering may be washable in a dishwasher.

The dog bowl with the covering may be microwaveable without causing damage to the container area, the indented area, the base, and/or the covering. The container area, the indented area, and/or the base may be made of a single mold of ceramic material formed in a shape (e.g., that simultaneously creates the container area, the indented area, and/or the base when the dog bowl is heated in a kiln oven during manufacture). The covering to be manufactured may have a variety of colors. The container area of the dog bowl may have a circular shape, a rectangular shape, a square shape, and/or a polygonal shape.

The indented area may be less than one inch in height and fully encircles the dog bowl. The covering to be constructed may be of a plastic material, a synthetic material, a rubber material, and/or a composite material.

In another aspect, a dog bowl includes a container area and an indented area below the container area formed of a metal material. A base of the dog bowl beneath the indented area is also formed of the metal material. A rubber covering is removably attached to the base of the dog bowl by physically clasping into the indented area when pulled over a base region into the indented area (e.g., such that the rubber covering fully encapsulates a bottom of the base of the dog bowl). The rubber covering prevents the dog bowl from slipping when a dog is eating food at an accelerated pace. The rubber covering remains clasped to the indented area while the dog is eating food from within the dog bowl.

The dog bowl with the rubber covering may be washable in a dishwasher. The dog bowl with the rubber covering may be microwaveable without causing damage to the container area, the indented area, the base, and/or the rubber covering. The rubber covering to be manufactured may have a variety of colors.

In yet another aspect, a dog bowl includes a container area and an indented area below the container area formed of a ceramic material. A base of the dog bowl beneath the indented area is also formed of the ceramic material. A covering is removably attached to the base of the dog bowl by physically clasping into the indented area when pulled over a base region into the indented area (e.g., such that the covering to fully encapsulate a bottom of the base of the dog bowl). The container area, the indented area, and/or the base is made of a single mold of ceramic material formed in a shape (e.g., that simultaneously creates the container area, the indented area, and/or the base when the dog bowl is heated in a kiln oven during manufacture).

### BRIEF DESCRIPTION OF THE FIGURES

Example embodiments are illustrated by way of example and not limitation in the figures of the accompanying drawings, in which like references indicate similar elements and in which:

FIG. 1A is a schematic view of a dog bowl, according to one embodiment.

FIG. 1B is a schematic view of the dog bowl with a rubber covering, according to one embodiment.

FIG. 2 is a conceptual view of a dog eating food from within the dog bowl with rubber covering of FIG. 1B, according to one embodiment.

Other features of the present embodiments will be apparent from the accompanying drawings and from the detailed description that follows.

### DETAILED DESCRIPTION

Disclosed is a dog bowl having an indented area to permit a rubber covering to removably attach, according to one embodiment.

In one embodiment, a dog bowl 150A includes a container area 102 and an indented area 104 below the container area 102 formed of a ceramic material. A base 106 of the dog bowl 150A beneath the indented area 104 is also formed of the ceramic material. A covering is removably attached to the base 106 of the dog bowl 150A by physically clasping into the indented area 104 when pulled over a base region into the indented area 104 (e.g., such that the covering fully encapsulates a bottom of the base 106 of the dog bowl 150A). The covering may prevent the dog bowl 150B from slipping when a dog 202 is eating food at an accelerated pace. The covering may remain clasped to the indented area 104 while the dog 202 is eating food from within the dog bowl 150B.

The dog bowl 150B with the covering may be washable in a dishwasher. The dog bowl 150B with the covering may be microwaveable without causing damage to the container area 102, the indented area 104, the base 106, and/or the covering. The container area 102, the indented area 104, and/or the base 106 may be made of a single mold of ceramic material formed in a shape (e.g., that simultaneously creates the container area 102, the indented area 104, and/or the base 106 when the dog bowl 150B is heated in a kiln oven during manufacture). The covering to be manufactured may be available in variety of colors. The container area 102 of the dog bowl 150B may have a circular shape, a rectangular shape, a square shape, and/or a polygonal shape.

The indented area 104 may be less than one inch in height and fully encircles the dog bowl 150B. The covering to be constructed may be of a plastic material, a synthetic material, a rubber material, and/or a composite material.

In another embodiment, a dog bowl 150A includes a container area 102 and an indented area 104 below the container area 102 formed of a metal material. A base 106 of the dog bowl 150A beneath the indented area 104 is also formed of the metal material. A rubber covering 108 is removably attached to the base 106 of the dog bowl 150A by physically clasping into the indented area 104 when pulled over a base region into the indented area 104 (e.g., such that the rubber covering 108 fully encapsulates a bottom of the base 106 of the dog bowl 150B). The rubber covering 108 prevents the dog bowl 150B from slipping when a dog 202 is eating food at an accelerated pace.

The rubber covering 108 remains clasped to the indented area 104 while the dog 202 is eating food from within the dog bowl 150B. The dog bowl with rubber covering 150B may be washable in a dishwasher. The dog bowl with rubber covering 150B may be microwaveable without causing damage to the container area 102, the indented area 104, the base 106, and/or the rubber covering 108. The rubber covering 108 to be manufactured may be available in variety of colors.

In yet another embodiment, a dog bowl 150A includes a container area 102 and an indented area 104 below the container area 102 formed of a ceramic material. A base 106 of the dog bowl 150A beneath the indented area 104 is also formed of the ceramic material. A covering (e.g., a rubber covering 108) is removably attached to the base 106 of the dog bowl 150A by physically clasping into the indented area 104 when pulled over a base region into the indented area 104 (e.g., such that the covering to fully encapsulate a bottom of the base 106 of the dog bowl 150B). The container area 102, the indented area 104, and/or the base 106 is made of a single mold of ceramic material formed in a shape (e.g., that simultaneously creates the container area 102, the indented area 104, and/or the base 106 when the dog bowl 150B is heated in a kiln oven during manufacture).

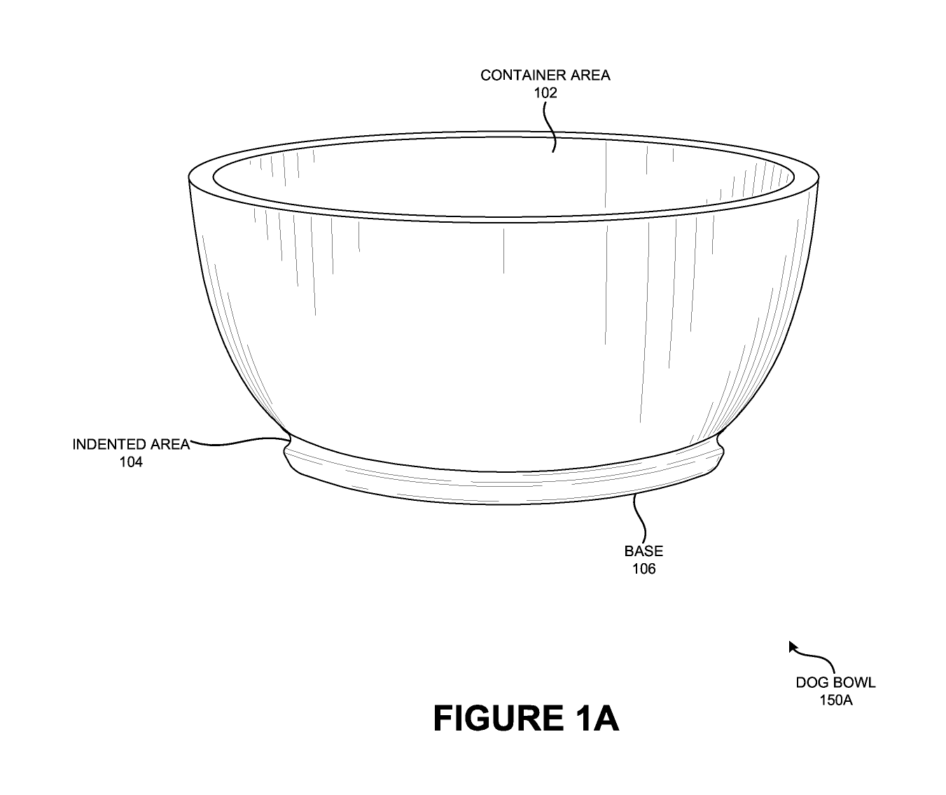

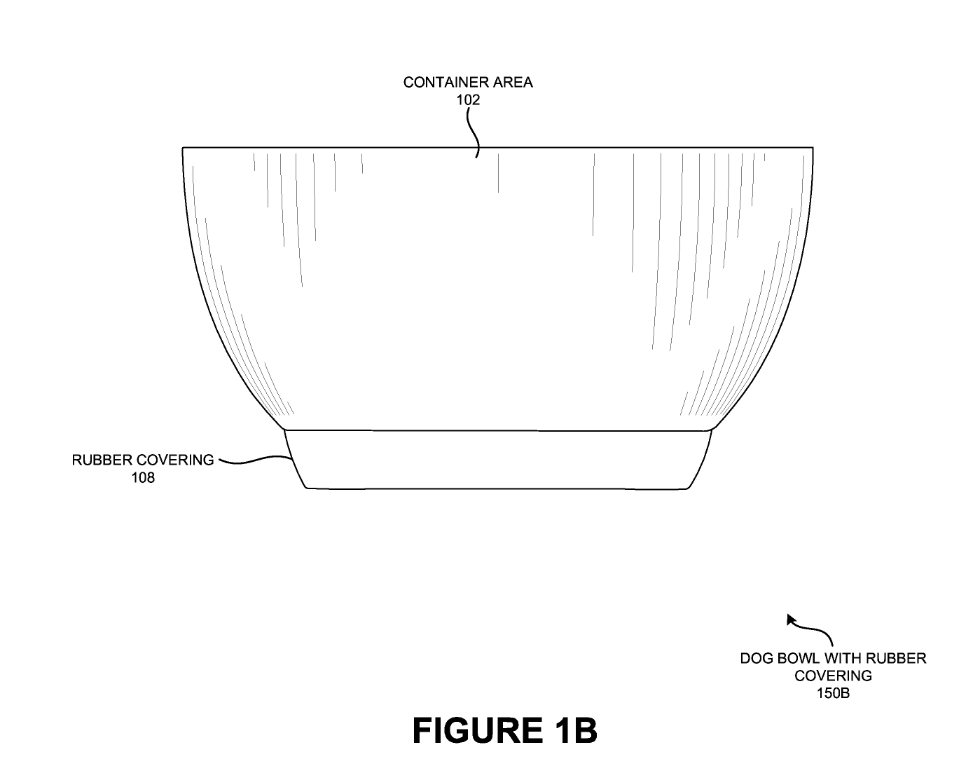

FIG. 1A is a schematic view of a dog bowl 150A, according to one embodiment. Particularly, the dog bowl 150A includes a container area 102, an indented area 104 and a base 106, according to one embodiment. The container area 102 may be a shallow region of the dog bowl 150A-B to hold food and/or liquid. The container area 102 may have a circular shape, a rectangular shape, a square shape, and/or a polygonal shape. The indented area 104 may be a deep notch at the bottom of the dog bowl 150A below the container area 102 and above the base 106. A base 106 may be a bottom area of the dog bowl 150A, according to one embodiment.

FIG. 1B is a schematic view of the dog bowl with rubber covering 150B, according to one embodiment. Particularly, FIG. 1B builds on FIG. 1A that illustrates a dog bowl with rubber covering 108, according to one embodiment. The rubber covering 108 may be a casing that tightly holds the indented area 104 and/or encloses the bottom of the base 106 of the dog bowl 150B, according to one embodiment. The rubber covering 108 may be removably attached to the base 106 of the dog bowl 150B by physically grasping into the indented area 104, according to one embodiment.

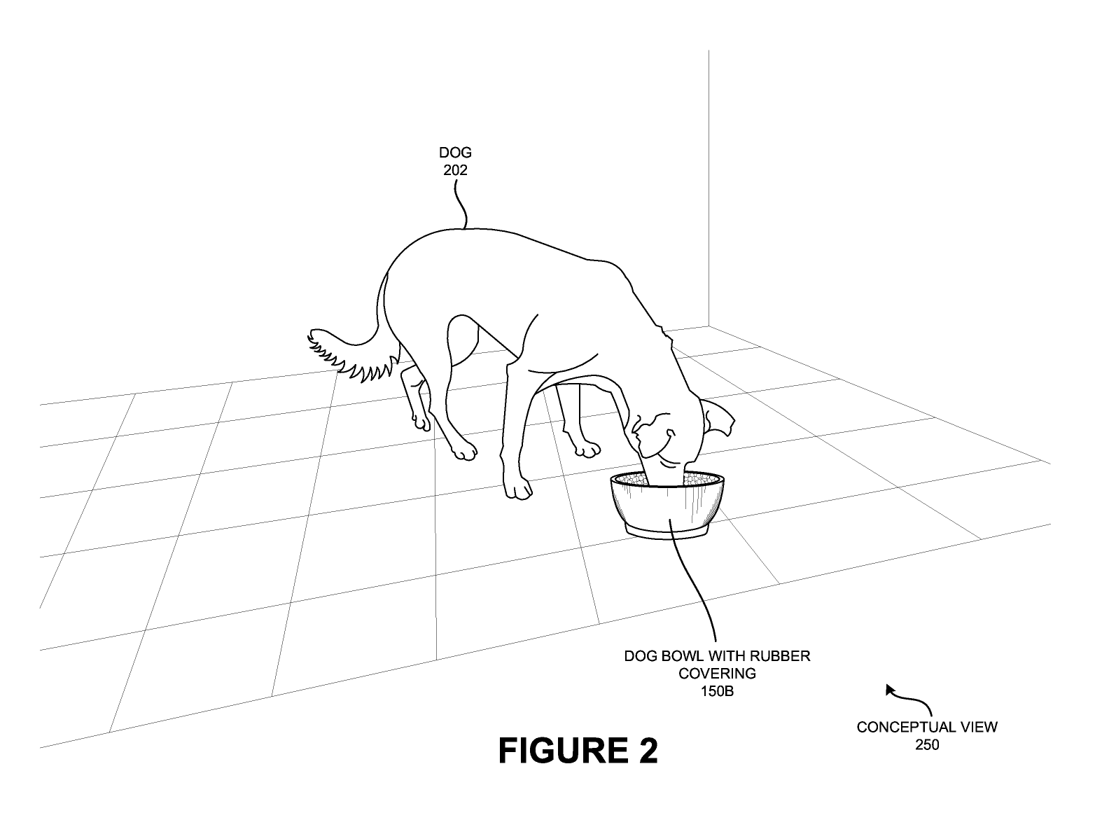

FIG. 2 is a conceptual view of a dog 202 eating food from within the dog bowl with rubber covering 150B, according to one embodiment. The dog 202 may be very hungry. The dog 202 may jump and/or reach for the food (e.g., over the bowl). The dog 202 may face number of challenges while eating food (e.g., the bowl may skid on the floor, the dog 202 may have to chase the food all over the floor). Also, during the feeding time the dog 202 may take the bowl filled with food elsewhere in the house (e.g., under the couch, under a kitchen cabinet) to continue eating. The dog owner (e.g., dog caretaker) may have to constantly clean the dog feeding area. The dog bowl with rubber covering 150B may make meal times easier and/or quieter for the dog 202. The non-skid bottom of the dog bowl with rubber covering 150B prevents the bowl from tipping, sliding, and/or slipping. The rubber covering 108 holds the dog bowl 150B in place and prevents the damage of floors and/or the dog bowl 150B.

An example embodiment will now be described. John may own a dog Bruno. The dog Bruno may show aggressive behavior when hungry. John may serve food to the dog Bruno in an ordinary dog bowl. The dog Bruno may gobble up the food from the ordinary dog bowl, causing the ordinary dog bowl to rattle about and/or eventually tip over. This may create a big mess, and cause health problems for both John and Bruno. The dog owner John may be annoyed to clean the house every time the dog Bruno finishes eating from eating food off the floor. Thankfully, one day, John may have learned about new advancements in dog bowl technology (e.g., as described in the FIGS. 1A-B) that may help to keep the dog bowl 150B stay in place thereby eliminating messes and/or help dogs such as Bruno who eat too quickly.

Bruno may benefit by eating from the dog bowl as described in the example embodiments (FIGS. 1A-B) by being able to more efficiently eat without the dog bowl tipping over. Further, John may no longer need to clean up messes created from the bowl tipping. Bruno may enjoy seeing different colors of rubber enclosures at the bottom of the dog bowl. John may save time by being able to both microwave and wash the dog bowl with the cover in place thanks to the technologies described in FIGS. 1A-B. This may improve both Bruno and John's quality of life.

The various embodiments of the dog bowl (FIGS. 1A-B) may secure the dog bowl at one place during the feeding time of the dog, according to one embodiment. The embodiments of the dog bowl 150A-B may prove particularly advantageous for the dogs who eat fast, according to one embodiment. It will be understood that while the dog bowl 150A-B is described as being made of metal material and/or ceramic material, the dog bowl 150A-B may be made of any type of material including any plastics, composites, natural, wooden, and/or synthetic materials.

A number of embodiments have been described. Nevertheless, it will be understood that various modifications may be made without departing from the spirit and scope of the claimed invention. Accordingly, other embodiments are within the scope of the following claims.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A dog bowl, comprising:
a container area of the dog bowl formed of a ceramic material;
an indented area of the dog bowl below the container area formed of the ceramic material;
a base of the dog bowl beneath the indented area of the dog bowl formed of the ceramic material; and
a covering,
wherein the covering to removably attach to the base of the dog bowl by physically clasping into the indented area when pulled over a base region into the indented area such that the covering to fully encapsulate a bottom of the base of the dog bowl.

2. The dog bowl of claim 1:
wherein the covering to prevent the dog bowl from slipping when a dog is eating food from within the dog bowl at an accelerated pace.

3. The dog bowl of claim 2, wherein the covering to remain clasped to the indented area while the dog is eating food from within the dog bowl.

4. The dog bowl of claim 1, wherein the dog bowl with the covering is washable in a dishwasher.

5. The dog bowl of claim 1, wherein the dog bowl with the covering is microwaveable without causing damage to any of the container area, the indented area, the base, and the covering.

6. The dog bowl of claim 1, wherein the container area, the indented area, and the base to be made of a single mold of ceramic material formed in a shape that simultaneously creates the container area, the indented area, and the base when the dog bowl is heated in a kiln oven during manufacture.

7. The dog bowl of claim 1, wherein the covering to be manufactured has a variety of colors.

8. The dog bowl of claim 1:
wherein the container area to have at least one of a circular shape, a rectangular shape, a square shape, and a polygonal shape, and
wherein the indented area is less than one inch in height and fully encircles the dog bowl.

9. The dog bowl of claim 1:
wherein the covering to be constructed of any one of a plastic material, a synthetic material, a rubber material, and a composite material.

10. A dog bowl, comprising:
a container area of the dog bowl formed of a metal material;
an indented area of the dog bowl below the container area formed of the metal material;
a base of the dog bowl beneath the indented area of the dog bowl formed of the metal material; and
a rubber covering,
wherein the rubber covering to removably attach to the base of the dog bowl by physically clasping into the indented area when pulled over a base region into the indented area such that the rubber covering to fully encapsulate a bottom of the base of the dog bowl,
wherein the rubber covering to prevent the dog bowl from slipping when a dog is eating food from within the dog bowl at an accelerated pace, and
wherein the rubber covering to remain clasped to the indented area while the dog is eating food from within the dog bowl.

11. The dog bowl of claim 10, wherein the dog bowl with the rubber covering is washable in a dishwasher.

12. The dog bowl of claim 11, wherein the dog bowl with the rubber covering is microwaveable without causing damage to any of the container area, the indented area, the base, and the rubber covering.

13. The dog bowl of claim 12, wherein the container area, the indented area, and the base to be made of a single mold of metal material formed in a shape that simultaneously creates the container area, the indented area, and the base when the dog bowl is heated in a kiln oven during manufacture.

14. The dog bowl of claim 13, wherein the covering to be manufactured has a variety of colors.

15. A dog bowl, comprising:
a container area of the dog bowl formed of a ceramic material;
an indented area of the dog bowl below the container area formed of the ceramic material;
a base of the dog bowl beneath the indented area of the dog bowl formed of the ceramic material; and
a covering,
wherein the covering to removably attach to the base of the dog bowl by physically clasping into the indented area when pulled over a base region into the indented area such that the covering to fully encapsulate a bottom of the base of the dog bowl, and
wherein the container area, the indented area, and the base to be made of a single mold of ceramic material formed in a shape that simultaneously creates the container area, the indented area, and the base when the dog bowl is heated in a kiln oven during manufacture.

16. The dog bowl of claim 15, wherein the covering to prevent the dog bowl from slipping when a dog is eating food from within the dog bowl at an accelerated pace.

17. The dog bowl of claim 16, wherein the covering to remain clasped to the indented area while the dog is eating food from within the dog bowl.

18. The dog bowl of claim 17, wherein the dog bowl with the covering is washable in a dishwasher.

19. The dog bowl of claim 18, wherein the dog bowl with the covering is microwaveable without causing damage to any of the container area, the indented area, the base, and the covering.

20. The dog bowl of claim 19, wherein the covering to be manufactured has a variety of colors.
